(19) United States
(12) Patent Application Publication
(10) Pub. No.: US 2008/0218329 A1
(43) Pub. Date: Sep. 11, 2008

(54) Vehicle breakdown warning sign

(76) Inventors: Shen Hsi FAN, Yi-Lan County (TW); Jin Shan Wang, Dongshan Township (TW)

Correspondence Address: ERIC CHAN, 42 PIN OAKS DRIVE, PHOENIXVILLE, PA, 19460, US

(21) Appl. No.: 11/683,998

(22) Filed: Mar. 8, 2007

(51) Int. Cl. B60Q 7/00

(52) U.S. Cl. 340/473

(57) ABSTRACT

An automobile breakdown warning sign includes a first, a second, and a third plates; one or a plurality of a set of light-emitting devices and a single chip controller being disposed on the first plate; both of the second and the third plates being each disposed with one or a plurality of a set of light-emitting devices, multiple electric connection portions, and one or a plurality of signal transmission module; all three plates being abutted to one another by their ends and electric connection portions to form a triangle frame for those light-emitting devices to become a triangle light-emitting unit; the single chip controller controlling those light emitting devices to alternatively flare while the signal transmission module sends a signal to be picked up by any following vehicle for providing early warning.

### BACKGROUND OF THE INVENTION

The present invention is related to a vehicle breakdown warning sign, and more particularly, to a warning sign comprised of light emitting device and transmitter module to provide visible warning to and send warning signals to be picked up those following vehicles for road safety.

When a vehicle breaks down on the road, the driver must provide a breakdown warning sign at a proper distance behind the vehicle to alert the following vehicles on the road. Usually, the warning sign is related to a triangle comprised of three plates with surface of each piece provided with an obvious feature that can be easily identified. The surface of each plate is adhered with a reflective sticker, coated with reflective film or varnish in bright color. In general, the identification feature is operative only at night since it has to reflect the light emitting from a following vehicle to make the warning sign visible so that the driver of the following vehicle may respond in time. However, the warning sign is not necessarily visible by the driver of the following vehicle even during night hours because that insufficient luminance or deflection of the emitting angle of the headlight from the following vehicle may miss the warning sign to relatively expose the driver of the following vehicle to higher risk of a smashup. Furthermore, if the breakdown occurs in a road section of heavy fog to compromise the visibility on the road, the driver of the following vehicle may not respond in time.

### BRIEF SUMMARY OF THE INVENTION

The primary purpose of the present invention is to provide a vehicle breakdown warning sign in a triangle comprised of three plates with each mounted with one or a plurality light emitting device to alternatively flare to upgrade safety and easy identification of the warning sign for safety concerns.

Another purpose of the present invention is to provide a vehicle breakdown warning sign, wherein each plate of the triangle is mounted with two sets of light emitting devices in different colors to alternatively flare to upgrade safety and easy identification of the warning sign for safety concerns.

Another purpose yet of the present invention is to provide a vehicle breakdown warning sign, wherein each plate is mounted with a pair of lift light guide plate to reduce the quantity of light emitting device and promote efficiency in use.

Another purpose yet of the present invention is to provide a vehicle breakdown warning sign, wherein one plate is mounted with a signal transmission module to send signals to be picked up by a following vehicle for providing early warning of the breakdown to the driver of the following vehicle.

To achieve these purposes, the present invention includes a first plate, a second plate, and a third plate. The first plate is mounted with one or a plurality of light emitting device and a single chip controller; and each of the second plate and the third plate is mounted with one or a plurality of light emitting device and multiple electric connection portions. Both ends of each of the first, the second, and the third plates are abutted to one another connection portion to connection portion and end to end to form a triangle frame that emits light. The single chip controller controls those light-emitting devices to alternatively flare while sending a signal from a single transmission module to warn the following vehicle in case of a breakdown on the road.

### BRIEF DESCRIPTION OF THE DRAWINGS

FIG. 1 is a perspective view of a first preferred embodiment of the present invention.

FIG. 2 is a front view of the first preferred embodiment of the present invention as assembled.

FIG. 3 is a schematic view showing an operation status of the first preferred embodiment of the present invention.

FIG. 4 is a schematic view showing another operation status of the first preferred embodiment of the present invention.

FIG. 5 is a perspective view of an assembly of a second preferred embodiment of the present invention.

FIG. 6 is a side view of the second preferred embodiment of the present invention.

FIG. 7 is a perspective view of an assembly of a third preferred embodiment of the present invention.

FIG. 8 is a perspective view of an assembly of a fourth preferred embodiment of the present invention.

FIG. 9 is a perspective view of an assembly of a fifth preferred embodiment of the present invention.

### DETAILED DESCRIPTION OF THE INVENTION

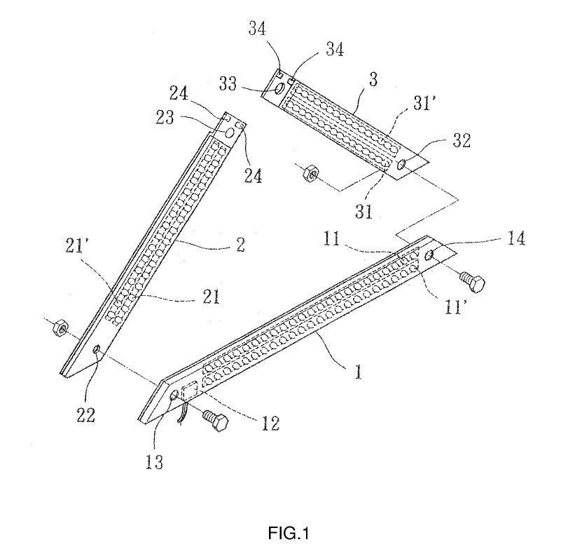

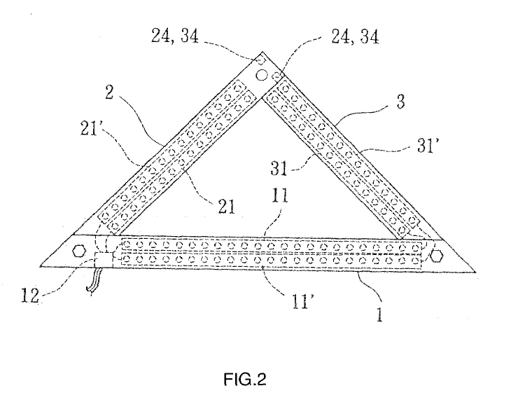

Referring to FIGS. 1 and 2, a first preferred embodiment of the present invention includes a first plate 1, a second plate 2, and a third plate 3. Wherein, the first plate 1 is disposed with two sets of light emitting devices 11 and 11′, a single chip controller 12, a power source bus (not illustrated), multiple (two in the preferred embodiment) signal buses (not illustrated), and two locating portions 13 and 14. Two sets of light emitting devices 11 and 11′ emit different colors from each other and are arranged in parallel with each other on the first plate 1. The light-emitting device is preferred to be a light-emitting diode (LED). The single chip controller 12 is integrated and built in the first plate 1 to drive both sets of light emitting devices 11 and 11′ with power supplied from the power source bus and transmit control signals through those signal buses to those light-emitting devices 11 and 11′. The single chip controller 12 is preferred to be a programmable one so to execute flexible control over those light-emitting devices 11 and 11′ to alternatively flare or other light emitting patterns. Each locating portions 13 and 14 is related to a gradation and/or a pivoting hole for both locating portions 13 and 14 to be respectively pivoted to the second plate 2 and the third plate 3.

The second plate 2 is disposed with two sets of light-emitting devices 21 and 21′, two locating portions 22 and 23, and multiple, and two in the preferred embodiment, electric connection portions 24. Those two sets of light-emitting devices 21 and 21′ emit light in different colors from each other and are arranged in parallel to each other on the second plate 2. Each of both locating portions 22 and 23 is related to a gradation, a pivoting hole, a nipple, and/or an indention (not illustrated) for both locating portions 22 and 23 to be respectively pivoted to the first plate 1 and the third plate 3. Both electric connection portions 24 are provided on the locating portion 23 and respectively connected to both light-emitting devices 21 and 21′.

Two sets of light-emitting devices 31 and 31, two locating portions 32 and 33, and multiple, two in this preferred embodiment, electric connection portions 34 are disposed on the third plate 3 of the first preferred embodiment. Both sets of light-emitting devices 31 and 31′ emit colors different from each other and are arranged in parallel with each other on the third plate 3. Each of both locating portions 32 and 33 is related to a gradation, a pivoting hole, a nipple, and/or an indention (not illustrated) for both locating portions 32 and 33 to be respectively pivoted to the first plate 1 and the second plate 2. Both electric connection portions 34 are disposed on the locating portion 33 and are electrically connected to both sets of light-emitting devices 31 and 31′ respectively. When both of the locating portions 23 and 33 are locked to each other, both of the electric connection portions 23 and 34 are electrically connected to each other. In a product design, both electric connection portions 24 and 34 form a closed loop or an open loop to function as a switch thus to control those light-emitting devices, 11, 11′, 21, 21′, 31, and 31′ to execute light emitting status.

As illustrated in FIG. 2, a pivoting device (e.g., a screw and a nut) is used to engage both locating portions 13, 22 to each other so to constitute a pivoting connection between the first plate 1 and the second plate 2. Multiple signal buses (not illustrated) are disposed at where between the first plate 1 and the second plate 2 to electrically connect to those light-emitting devices 11, 11′, 21, and 21′.

The first plate 1 constitutes another pivoting connection with the third plate 3 by having another pivoting device (not illustrated) to engage both locating parts 14 and 32 to each other. Multiple signal buses connect those light-emitting devices 11, 11′, 31, and 31′ from the first plate 1 and the third plate 3. When the vehicle breakdown warning sign is placed in use, both of the second plate 2 and the third plate 3 are properly pivoted to a proper angle until both locating portions 23 and 33 are laid flushed to each other for the first, the second, and the third plates 1, 2, and 3 to form a triangle frame. Meanwhile, three sets of light-emitting devices 11, 21, and 31 jointly form a light-emitting unit on the inner perimeter of the triangle frame. Similarly, those three sets of light-emitting devices 11′, 21′ and 31′ jointly form another triangle light-emitting unit on the outer perimeter of the triangle frame. The light-emitting unit on the outer perimeter of the triangle frame comprised of those light-emitting devices 11′ 21′, and 31′ is disposed externally to surround the light-emitting unit on the inner perimeter of the triangle frame comprised of those light-emitting devices 11, 21, and 31.

The single chip controller 12 controls those light-emitting devices 21, 21′ to form a loop by means of the signal bus (not illustrated). Similarly, the single chip controller 12 provides a set of signals through the signal bus (not illustrated) to those light-emitting devices 31 and 31′ on the third plate 3 while both of the second plate 2 and the third plate 3 are electrically connected by means of both electric connection portions 24 and 34 respectively from both locating portions 23 and 33. The chip controller 12 is related to a programmable device that is capable of adjusting the load of the light-emitting device. When the single chip controller 12 is actuated by a power source bus (not illustrated) to drive the signal bus, those light-emitting devices 11, 21, and 31 form the inner light-emitting unit to emit the light of same color; and those light-emitting devices, 11′, 21′, and 31′ form through electric connection the outer light-emitting unit to emit light in a color different from that from the inner light-emitting unit. Both light-emitting units emit light to warn a following vehicle either in the fashion of alternatively flaring or other fashion as controlled. Accordingly, the vehicle breakdown warning sign of the present invention is capable of providing flexible planning of its identification pattern and upgrade visibility of the identification.

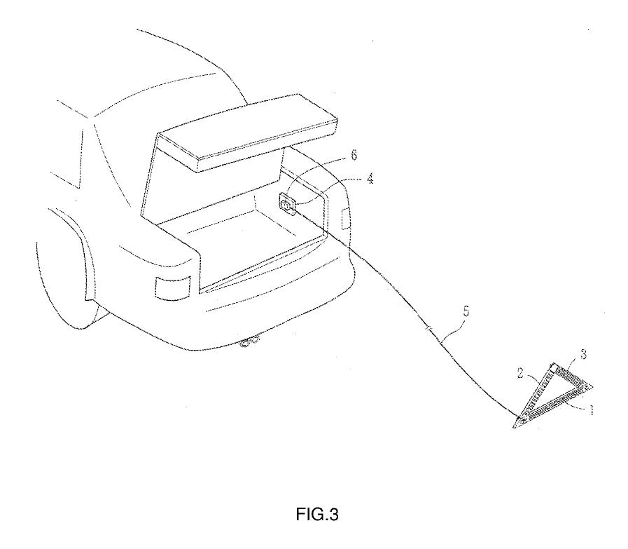

Now referring to FIGS. 2 and 3 showing an operation status of the first preferred embodiment of the present invention, a vehicle breaks down on the road and the driver may place the breakdown warning sign of the present invention at a location behind the vehicle for a proper range or may fix the warning sign to the inner wall of the trunk of the vehicle and open up the trunk. The warning sign is powered by a power source conversion system 4 through a power line 5, which is electrically connected to the single chip controller 12. Alternatively, a battery unit 6 may be inserted to the power source conversion system 4 to charge the warning sign and maintain its power storage status.

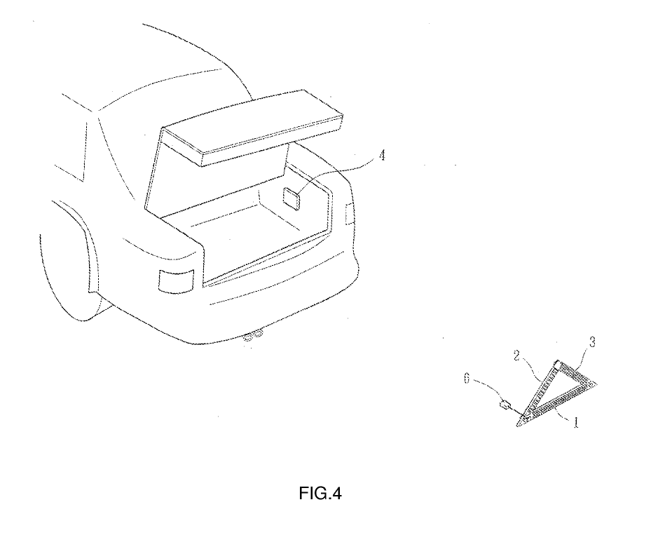

As illustrated in FIGS. 2 and 4 showing another operation status of the first preferred embodiment of the present invention, the battery unit 6 fully charged is removed from the power source conversion system 4 to become an external source to directly supply power to the warning sign of the present invention. The battery unit 6 may be electrically connected to the power source bus (not illustrated) to further facilitate the user of the warning sign.

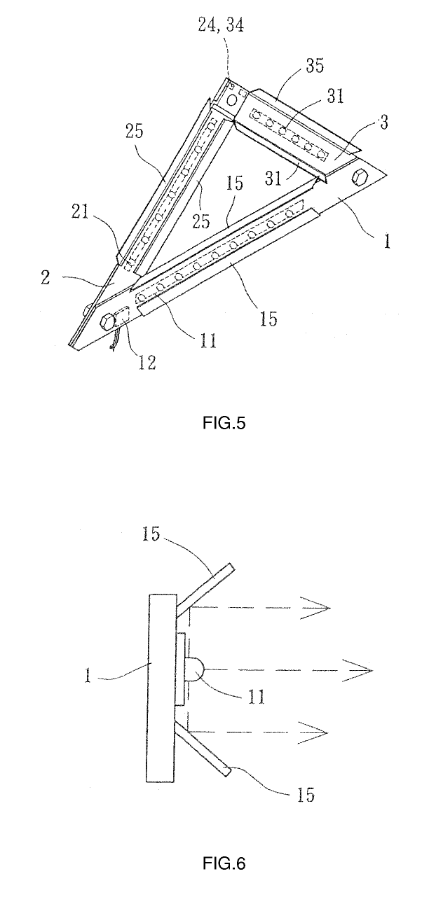

A second preferred embodiment of the present invention as illustrated in FIGS. 5 and 6 is further adapted with two light guide plates 15 to guide streams of light emitted from the set of light-emitting devices 11 disposed on the first plate 1; another two light guide plates 25 to guide streams of light emitted for the set of light-emitting devices 21 disposed on the second plate 2; and another two light guide plates 35 yet to guide streams of light emitted form the set of light-emitting devices 31 disposed on the third plate 3. Each of those light guide plates 15 and 25, and 35 is pivoted to a pre-designated angle respectively in relation to the first, the second, and the third plates 1, 2, and 3. When those light-emitting devices 11, 21, and 31 are driven by the single chip controller 12, streams of light emitted are constantly reflected and guided to a given direction respectively through those light guide plates, 15, 25, and 35. Accordingly, emission efficiency is increased for those streams of light emitted from those light-emitting devices 11, 21, and 31 thus to reduce the quantity of light-emitting device as may be required. Meanwhile the single chip controller 12 is capable of making flexible adjustment of source luminance for those light-emitting devices 11, 21, and 31 to extend their service life.

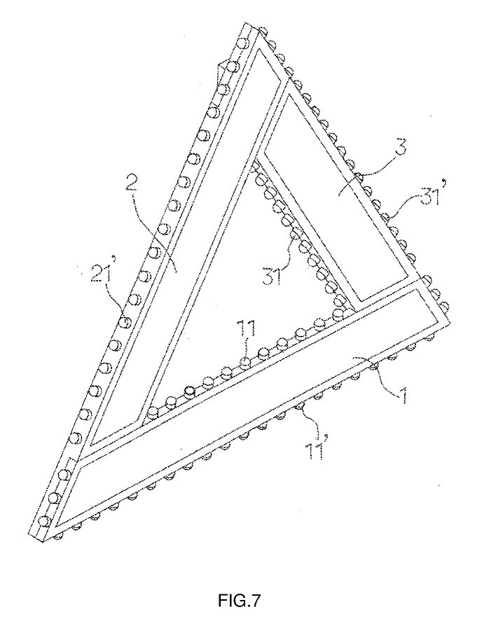

As illustrated in FIG. 7, those light-emitting devices 11, 11′, 21, 21′, 31, and 31′ are respectively disposed on the inner edge and the outer edge of the triangle frame comprised of the first, the second, and the third plates to achieve the same purpose of equivalent replacement.

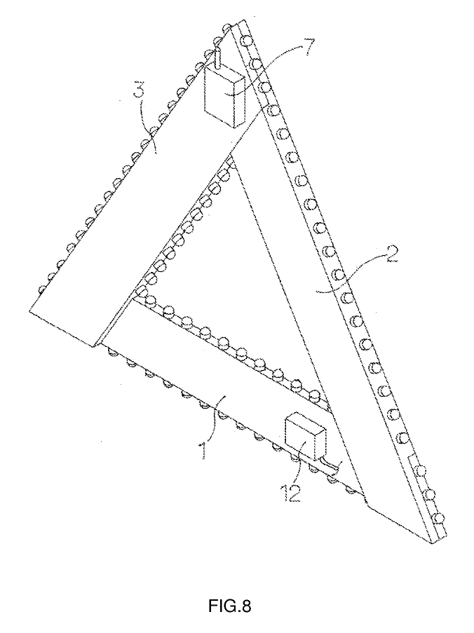

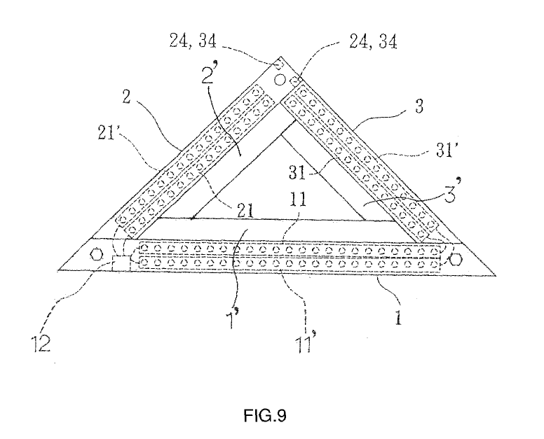

A signal transmission module 7 may be further disposed to any of the first plate 1, the second plate 2, or the third plate 3 as illustrated in FIG. 8 to form a control loop similar to that of the single chip controller 12. A passage is then formed by connecting both locating portions 23 and 33 respectively of both locating portions 23 and 33 from the second and the third plates 2 and 3 to start the signal transmission module 7 to send a signal to be picked by a following vehicle for the driver of the following vehicle to have early warning of the breakdown for further improvement of the warning results.

Each of those light-emitting devices 11, 11′, 21, 21′, 31, and 31′ may be related to a cold light emitting object.

A first plate 1′, a second plate 2′, and a third plate 3′ may be further disposed to the inner edge or the outer edge respectively of the first plate 1, the second plate 2, and the third plate 3 to provide another triangle frame with conventional functions of a warn sign. That is, the first plate 1′, the second plate 2′, and the third plate 3′ is each adhered with a reflective sticker or film to become a prior art of the warning sign incorporated to the present invention for the present invention to become a dual-purpose warning sign.

Accordingly, the present invention corrects the problem of limited warning results as found with the prior art simply by adhering a reflective sticker or a reflective film, or applying varnish to the surface of the triangle frame. As illustrated in FIG. 2, the vehicle breakdown warning sign of the present invention comprised of the first, the second, and the third plates, 1, 2, and 3; and those three plates 1, 2, and 3 are respectively disposed with a set of light-emitting devices 11, 21, and 31 to emit streams of light in different colors for producing actively alternative flaring results to warn the following vehicle. The present invention significantly upgrades the easy identification of a breakdown of a vehicle to upgrade the safety of the driver in performing the troubleshooting and the safety of the following vehicle.

It is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A vehicle breakdown warning sign includes a triangle frame comprised of a first plate, a second plate, and a third plate; one or a plurality of a set of light-emitting devices being respectively disposed on the first plate, the second plate, and/or the third plate.

2. The vehicle breakdown warning sign as claimed in claim 1, wherein a second set of light-emitting devices is disposed to the first plate, the second plate, and/or the third plates to emit light in color different from the first set of light-emitting devices.

3. The vehicle breakdown warning sign as claimed in claim 1, wherein the first plate is provided with two locating portions.

4. The vehicle breakdown warning sign as claimed in claim 1, wherein the second plate is disposed with two locating portions and multiple electric connection portions on either of the locating portion to electrically connected to the set of light-emitting devices disposed on the second plate.

5. The vehicle breakdown warning sign as claimed in claim 1, wherein the third plate is disposed with two locating portions and multiple electric connection portions on either of the locating portion to electrically connected to the set of light-emitting devices disposed on the third plate.

6. The vehicle breakdown warning sign as claimed in claim 1, wherein the first plate, the second plate, and the third plate form a triangle frame by means of engaging those locating portions; and those electric connection portions from the second and the third plates are electrically connected to one another to actuate those light-emitting devices.

7. The vehicle breakdown warning sign as claimed in claim 1, wherein those locating portions respectively from the first, the second, and the third plates are related to gradations, pivoting holes, nipples, and/or indentions.

8. The vehicle breakdown warning sign as claimed in claim 1, wherein locating portions from the first, the second, and the third plates are pivoted to one another respectively by means of a pivoting device.

9. The vehicle breakdown warning sign as claimed in claim 1, wherein a single ship controller is included to control those light-emitting devices to alternatively flare and the single chip controller is related to a programmable one.

10. The vehicle breakdown warning sign as claimed in claim 1, wherein one or a plurality of lift light guide plate is each disposed to the first, the second, and the third plates to guide and reflect streams of light emitted from those light-emitting devices.

11. The vehicle breakdown warning sign as claimed in claim 1, wherein a power source and a power source bus are further provided to actuate and drive the single chip controller and those light-emitting devices.

12. The vehicle breakdown warning sign as claimed in claim 1, wherein the power source is related to a car-boarded power source conversion system.

13. The vehicle breakdown warning sign as claimed in claim 1, wherein the power source relates to a battery unit.

14. The vehicle breakdown warning sign as claimed in claim 1, wherein a signal transmission module is disposed on the first plate, the second plate, or the third plate; and the signal transmission module and the single chip controller form a loop.

15. The vehicle breakdown warning sign as claimed in claim 1 wherein another set of a first, a second, and a third plates is further respectively disposed to the inner edge or the outer edge of the first, the second, and the third plates to form another triangle frame to the existing one.
